(19) United States
(12) Patent Application Publication
(10) Pub. No.: US 2014/0245131 A1
(43) Pub. Date: Aug. 28, 2014

(54) MOBILE DEVICES AND METHODS OF OPERATING THE SAME

(71) Applicant: Samsung Electronics Co., Ltd., Suwon-Si (KR)

(72) Inventor: Du MAOHUA, Suzhou City (CN)

(73) Assignee: Samsung Electronics Co., Ltd., Suwon-Si (KR)

(21) Appl. No.: 14/187,796

(22) Filed: Feb. 24, 2014

(30) Foreign Application Priority Data
Feb. 27, 2013 (CN) 201310060095.1
Dec. 30, 2013 (KR) 10-2013-0167245

(51) Int. Cl. G06F 17/22

(52) U.S. Cl. CPC G06F 17/2247
USPC 715/234

(57) ABSTRACT

A mobile device may include: an interface unit configured to receive first uniform resource locator (URL) information from a user, and configured to receive second URL information; a web data loading unit configured to load a first web page corresponding to the first URL information, and configured to load a second web page corresponding to the second URL information; a determining unit configured to compare the first and second URL information to determine whether the first web page is related to the second web page and to generate a first control signal; a scale control unit configured to generate a scale control signal corresponding to scale information of the first web page in response to the first control signal; and/or a display unit configured to receive the scale control signal to display the second web page in a scale corresponding to the scale information of the first web page.

### CROSS-REFERENCE TO RELATED APPLICATION(S)

This application claims priority from Chinese Patent Application No. 201310060095.1, filed on Feb. 27, 2013, in the State Intellectual Property Office (SIPO) of the People's Republic of China, and Korean Patent Application No. 10-2013-0167245, filed on Dec. 30, 2013, in the Korean Intellectual Property Office (KIPO), the entire contents of both of which are incorporated herein by reference.

### BACKGROUND

1. Field

Some example embodiments of the inventive concepts relate to mobile devices and/or methods of operating the same. Some example embodiments of the inventive concepts relate to mobile devices capable of conveniently and efficiently providing web pages to users and/or methods of operating the same.

2. Description of Related Art

As mobile technology is developed and mobile devices are in everyday use, methods of user accessing a web in mobile devices to conveniently watch web pages may be desired.

### SUMMARY

Some example embodiments of the inventive concepts provide mobile devices capable of conveniently and efficiently providing web pages to users and/or methods of operating the same.

In some example embodiments, a mobile device may comprise: an interface unit configured to receive first uniform resource locator (URL) information from a user, and configured to receive second URL information; a web data loading unit configured to load a first web page corresponding to the first URL information from a web server that the first URL information represents, and configured to load a second web page corresponding to the second URL information from a web server that the second URL information represents; a determining unit configured to compare the first URL information with the second URL information to determine whether the first web page is related to the second web page and to generate a first control signal; a scale control unit configured to generate a scale control signal corresponding to scale information of the first web page in response to the first control signal; and/or a display unit configured to receive the scale control signal to display the second web page in a scale corresponding to the scale information of the first web page.

In some example embodiments, the determining unit may comprise a URL analyzer for comparing the first URL information and the second URL information continuously input to the interface unit with each other to determine whether the second web page is continuous to the first web page and to generate the first control signal.

In some example embodiments, the determining unit may comprise a URL analyzer for comparing the second URL information to the first URL information to determine whether the second web page is the same as or continuous to the first web page and to generate the first control signal. The second URL information may be input to the interface unit after the first URL information is received and then at least one other URL information may be received.

In some example embodiments, the determining unit may comprise a URL analyzer configured to determine whether the first URL information and the second URL information are the same, excluding information resource names included therein, and when it is determined that the first URL information and the second URL information are the same, excluding the information resource names included therein, configured to compare the information resource names of the first URL information and the second URL information with each other to generate the first control signal.

In some example embodiments, the scale control unit may be configured to generate the scale control signal corresponding to a default value in the display unit displaying a web page when the first control signal represents that the first web page and the second web page are not related to each other, and is configured to generate the scale control signal corresponding to scale information of the second web page when scale information of the second web page is input to the interface unit. The display unit may be configured to display the second web page in a scale in accordance with the scale control signal.

In some example embodiments, a method of watching continuous web pages in a mobile device may comprise: controlling storage in order to store page display scale control data input by a user; comparing a uniform resource locator (URL) of a current page with that of a previous page to analyze a relationship between the current page and the previous page when a page turning command input by the user is received; and/or loading a page in accordance with the analysis result.

In some example embodiments, the loading of the page in accordance with the analysis result may comprise: loading the current page by using the stored page display scale control data when it is determined that the current page is related to the previous page; and/or loading the current page by using default display scale control data when it is determined that the current page is not related to the previous page.

In some example embodiments, the analyzing of the relationship between the current page and the previous page may comprise: comparing characters of a part of the URL of the current page with those of a part of the URL of the previous page to determine that the current page is related to the previous page when all the characters of the part of the URL of the current page are the same as those of the part of the URL of the previous page.

In some example embodiments, the characters of the part may comprise all the characters before a last symbol “/” of the URL.

In some example embodiments, when continuous characters follow a character “html”, “shtml”, or “htm” in at least one of the URLs of the current page and the previous page, the characters of the part may further comprise all the characters between the last symbol “/” and a symbol “.” after the last symbol “/”.

In some example embodiments, when no continuous characters follow a character “html”, “shtml”, or “htm” in at least one of the URLs of the current page and the previous page, the characters of the part may further comprise all the characters between the last symbol “/” and a first character that is not a number before a symbol “.” after the last symbol “/”.

In some example embodiments, a mobile device may comprise: a storage controller configured to control storage in order to store page display scale control data input by a user; a uniform resource locator (URL) analyzer configured to compare a URL of a current page with that of a previous page to analyze a relationship between the current page and the previous page when a page turning command input by a user is received; and/or a page loader configured to load the current page in accordance with the analysis result.

In some example embodiments, the page loader may be configured to load the current page by using the stored page display scale control data when it is determined by the URL analyzer that the current page is related to the previous page. The page loader may be configured to load the current page by using default display scale control data when it is determined by the URL analyzer that the current page is not related to the previous page.

In some example embodiments, the URL analyzer may be configured to compare characters of a part of the URL of the current page with those of a part of the URL of the previous page to determine that the current page is related to the previous page when it is determined that all characters of the part of the URL of the current page are the same as those of the part of the URL of the previous page.

In some example embodiments, characters of the part may comprise all the characters before a last symbol “/”. When continuous characters follow a character “html”, “shtml”, or “htm” in at least one of the URLs of the current page and the previous page, the characters of the part may further comprise all the characters between the last symbol “/” and a symbol “.” after the last symbol “/”. When no continuous characters follow the character “html”, “shtml”, or “htm” in at least one of the URLs of the current page and the previous page, the characters of the part may further comprise all the characters between the last symbol “/” and the first character that is not a number before the symbol “.” after the last symbol “/”.

In some example embodiments, a mobile device may comprise: a touch panel configured to receive first uniform resource locator (URL) information from a user, and configured to receive second URL information; a web data loading unit configured to load a first web page corresponding to the first URL information from a web server that the first URL information represents, and configured to load a second web page corresponding to the second URL information from a web server that the second URL information represents; a determining unit configured to compare the first URL information with the second URL information to determine whether the first web page is related to the second web page and to generate a first control signal; and/or a scale control unit configured to generate a scale control signal corresponding to scale information of the first web page in response to the first control signal, and configured to provide the scale control signal to the touch panel.

In some example embodiments, the mobile device may further comprise: a display unit configured to display the second web page in a scale corresponding to the scale information of the first web page.

In some example embodiments, the touch panel may further comprise: a display unit configured to display the second web page in a scale corresponding to the scale information of the first web page.

In some example embodiments, the mobile device may further comprise: a display unit configured to receive the scale control signal to display the second web page in a scale corresponding to the scale information of the first web page.

In some example embodiments, the touch panel may further comprise: a display unit configured to receive the scale control signal to display the second web page in a scale corresponding to the scale information of the first web page.

### BRIEF DESCRIPTION OF THE DRAWINGS

The above and/or other aspects and advantages will become more apparent and more readily appreciated from the following detailed description of example embodiments, taken in conjunction with the accompanying drawings, in which:

FIG. 1 is a view illustrating a mobile device according to some example embodiments of the inventive concepts;

FIG. 2 is a view illustrating an example embodiment of the mobile device of FIG. 1;

FIG. 3 is a view illustrating an example embodiment of scale information in the mobile device of FIG. 1;

FIG. 4 is a view illustrating an example embodiment of the scale controller of FIG. 1;

FIG. 5 is a view illustrating an example embodiment of an operation of the scale control unit of FIG. 4;

FIG. 6 is a view illustrating an example embodiment of the determining unit of FIG. 1;

FIG. 7 is a view illustrating an example embodiment of uniform resource locator (URL) information determined by the determining unit of FIG. 6;

FIG. 8 is a flowchart illustrating an example embodiment of an operation of the determining unit of FIG. 6;

FIG. 9 is a view illustrating an example embodiment of an operation in contrast with an operation of a mobile device according to some example embodiments of the inventive concepts;

FIG. 10 is a view more conceptually illustrating the mobile device of FIG. 1;

FIG. 11 is a flowchart illustrating an example embodiment of a method of analyzing URL by the URL analyzer of FIG. 10;

FIG. 12 is a flowchart illustrating a method of watching continuous web pages in a mobile device according to some example embodiments of the inventive concepts; and

FIG. 13 is a view illustrating an example of an electronic device according to some example embodiments of the inventive concepts.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Example embodiments may be described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will typically have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature, their shapes are not intended to illustrate the actual shape of a region of a device, and their shapes are not intended to limit the scope of the example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

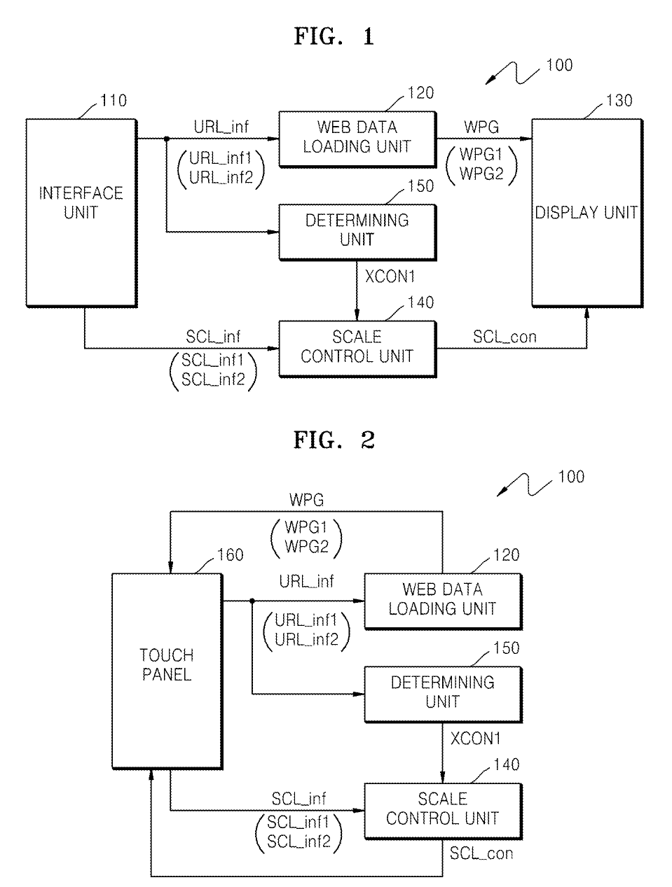

FIG. 1 is a view illustrating a mobile device according to some example embodiments of the inventive concepts. Referring to FIG. 1, a mobile device 100 according to some example embodiments of the inventive concepts includes an interface unit 110, a web data loading unit 120, a display unit 130, a scale control unit 140, and a determining unit 150. The interface unit 110 interfaces with a user. For example, the interface unit 110 may receive uniform resource locator (URL) or bookmark information of a web page desired to access from the user. Hereinafter, for convenience sake, information on a URL of a web page desired to access, which is provided by a user, is referred to as URL information URL_inf.

For example, the interface unit 110 may include a touch keypad and may receive the URL through a touch of the touch keypad, the interface unit 110 may provide an application icon connected to an arbitrary URL through a touch panel and may receive the URL by the user touching the corresponding application icon, or the interface unit 110 may receive the URL by the user touching or clicking a link included in a displayed web page WPG.

The web data loading unit 120 receives the URL information URL_inf to receive data for loading the web page WPG (for example, web data) from a web server related to the URL information URL_inf. For example, the web data loading unit 120 may include data such as a Hyper Text Markup Language (HTML), a Java scripter, and an image corresponding to the web page WPG. The web data loading unit 120 may be combined with the interface unit 110. The mobile device 100 may perform the above-described communication through a communication driver (not shown).

The display unit 130 receives the web page WPG from the web data loading unit 120 to display the received web page WPG. The display unit 130 may include a touch panel. In this case, the interface unit 110 and the display unit 130 of FIG. 1 may share a touch panel 160 as illustrated in FIG. 2. In FIG. 2, logics of the interface unit 110 and the display unit 130 excluding the touch panel 160 are not shown.

Referring to FIG. 1 again, the user may watch the web page WPG through the display unit 130. When the web page WPG is displayed through the display unit 130, the user may increase or reduce a scale of the displayed web page WPG. The scale control unit 140 of the mobile device 100 receives scale information SCL_inf transmitted by the user through the interface unit 110 to transmit a scale control signal SCL_con to the display unit 130. The display unit 130 controls the scale of the displayed web page WPG in response to the scale control signal SCL_con. For example, the scale information SCL_inf may correspond to information on a touch performed by the user on the interface unit 110, for example, the touch panel (or touch coordinates). The touch information may be sensed by a touch sensor of the touch panel.

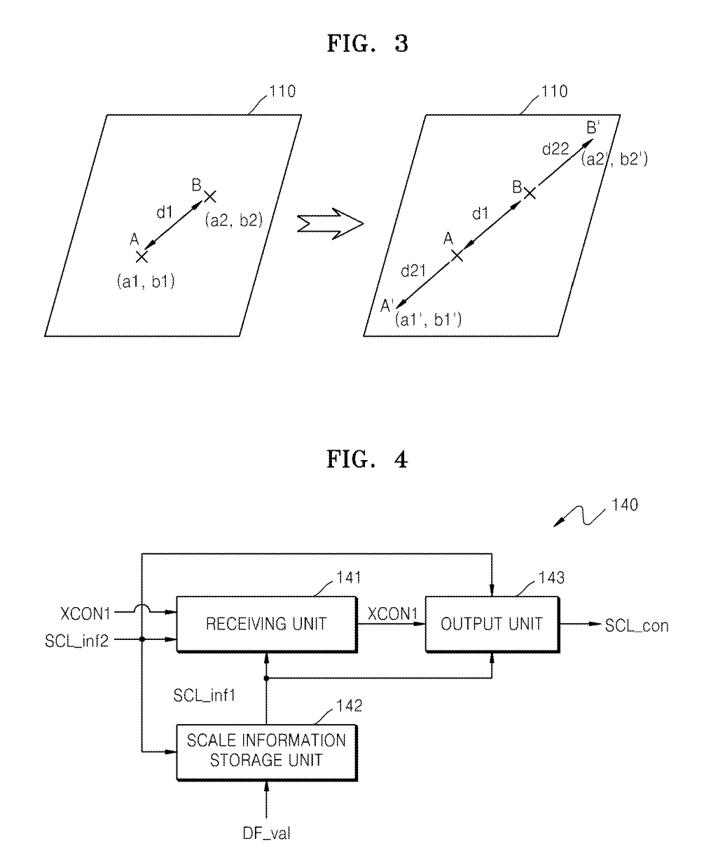

For example, the user may control the increase or reduction in the scale of the displayed web page WPG by the scale control unit 140 in response to the scale information SCL_inf corresponding to the touch. For example, when the user increases (d1+d21+d22) a distance d1 between two (or two or more) touches A(a1, b1) and B(a2, b2) on the touch panel as illustrated in FIG. 3, the scale control unit 140 may receive a change in the touch information (the touch coordinates) (a change in the touch coordinates from A and B to A′ and B′) to output the scale control signal SCL_con for increasing the scale of the displayed web page WPG. When the user reduces the distance between the two or more touches on the touch panel, the scale control unit 140 may output the scale control signal SCL_con for reducing the scale of the displayed web page WPG. When the user continuously generates touches on the touch panel or generates a touch for no less than a desired time (that may or may not be predetermined), the scale control unit 140 may receive the generated touches as the scale information SCL_inf to output the scale control signal SCL_con for increasing the scale of the displayed web page WPG.

In the above example embodiments, the touch may be a direct touch or a hovering touch on the touch panel. In addition, the scale information SCL_inf may be input not by the touch panel but by an input button. When the scale information SCL_inf is not input, the scale control unit 140 may generate the scale control signal SCL_con so that the web page WPG is displayed in a scale set as default.

Referring to FIG. 1, the determining unit 150 receives the URL information URL_inf to determine a relationship between web pages WPG required to access. For example, the determining unit 150 may determine whether continuously received URL information items URL_inf are URL information items URL_inf on continuous web pages WPG to output a first control signal XCON1. For example, the determining unit 150 may determine whether non-continuously received URL information items URL_inf are URL information items URL_inf on the same or continuous web pages WPG to output the first control signal XCON1. Hereinafter, for convenience sake, previously received URL information URL_inf is referred to as first URL information URL_inf1 and URL information URL_inf received later, that is, currently received URL information URL_inf is referred to as second URL information URL_inf2. In addition, a web page WPG corresponding to the first URL information URL_inf1 is referred to as a first web page WPG1 and a web page WPG corresponding to the second URL information URL_inf2 is referred to as a second web page WPG2.

The first URL information URL_inf1 and the second URL information URL_inf2 may be continuously received. That is, after the first URL information URL_inf1 is received, the second URL information URL_inf2 may be received or, after the first URL information URL_inf1 is received, at least one URL information item may be further received and then, the second URL information URL_inf2 may be received. At this time, the second URL information URL_inf2 may be newly received by a page turning command of the user. In addition, the URL information may be newly received as the second URL information URL_inf2 not by the additional page turning command but by the above-described touch of the user. As described above, the determining unit 150 determines correlativity between the first web page WPG1 and the second web page WPG2 to generate the first control signal XCON1. An operation of the determining unit 150 will be described in detail later.

FIG. 4 is a view illustrating an example embodiment of the scale control unit 140 of FIG. 1. Referring to FIGS. 1 and 4, the scale control unit 140 may include a receiving unit 141, a scale information storage unit 142, and an output unit 143. The receiving unit 141 receives the scale information SCL_inf and the first control signal XCON1. The scale information SCL_inf may be received by the user performing the touch through a user interface (for example, the touch panel) as described above. The first control signal XCON1 may be received as a first value (for example, 1) when it is determined by the determining unit 150 that the first web page WPG1 and the second web page WPG2 are related to each other. The first control signal XCON1 may be input prior to or later than the scale information SCL_inf2 on the second web page WPG2 or the scale information SCL_inf2 on the second web page WPG2 and the first control signal XCON1 may be simultaneously input to the scale control unit 140.

When the scale information SCL_inf2 on the second web page WPG2 is not input, the receiving unit 141 may transmit the first control signal XCON1 to the output unit 143. The output unit 143 outputs one of the scale information SCL_inf1 on the first web page WPG1 and a default value DF_val stored in the scale information storage unit 142 as the scale control signal SCL_con in response to the first control signal XCON1. For example, when the first control signal XCON1 represents that the first web page WPG1 and the second web page WPG2 are related to each other, the output unit 143 may output the scale information SCL_inf1 on the first web page WPG1 stored in the scale information storage unit 142 as the scale control signal SCL_con. On the other hand, when the first control signal XCON1 represents that the first web page WPG1 and the second web page WPG2 are not related to each other, the output unit 143 may output the default value DF_val as the scale control signal SCL_con.

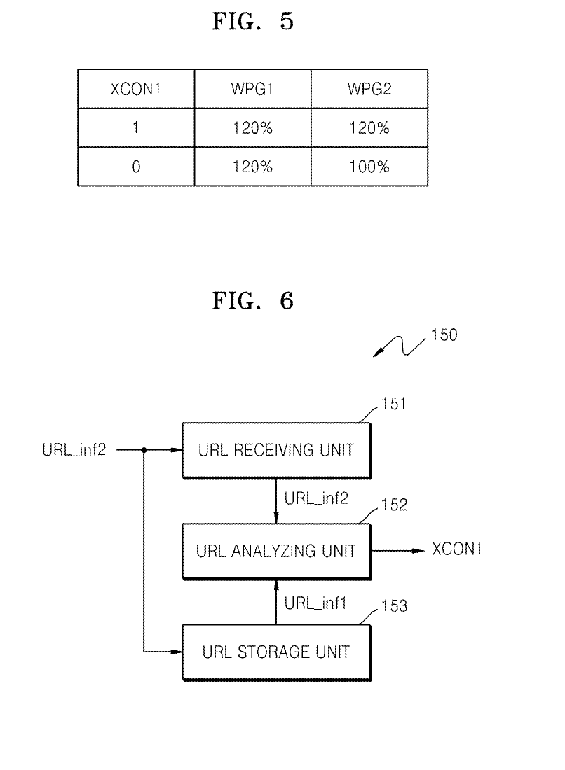

For example, as illustrated in FIG. 5, when the first web page WPG1 and the second web page WPG2 are related to each other, the determining unit 150 may generate the first control signal XCON1 having the value of 1 and the scale control unit 140 may set a scale of the second web page WPG2 displayed or to be displayed by the display unit 130 as 120%, which is equal to that of the first web page WPG1, in response to the first control signal XCON1 having the value of 1. As described above, the first web page WPG1 and the second web page WPG2 may be continuous web pages or the same web page. On the other hand, when the first web page WPG1 and the second web page WPG2 are not related, the determining unit 150 may generate the first control signal XCON1 having the value of 0 and the scale control unit 140 may set a scale of the second web page WPG2 displayed or to be displayed by the display unit 130 as 100% set as default regardless of that of the first web page WPG1 in response to the first control signal XCON1 having the value of 0.

Referring to FIGS. 1 and 4, when the scale information SCL_inf2 on the second web page WPG2 is received after the first control signal XCON1 is received or at the same time when the first control signal XCON1 is received, the receiving unit 141 may transmit the scale information SCL_inf2 on the second web page WPG2 to the output unit 143. In this case, the output unit 143 outputs the scale information CL_inf2 on the newly input second web page WPG2 as the scale control signal SCL_con. As described above, the display unit 130 controls the scale of the displayed web page in response to the scale control signal SCL_con. When the scale information SCL_inf2 on the second web page WPG2 is received, the receiving unit 141 stores the scale information SCL_inf2 on the second web page WPG2 in the scale information storage unit 142.

FIG. 6 is a view illustrating an example embodiment of the determining unit 150 of FIG. 1. Referring to FIGS. 1 and 6, the determining unit 150 may include a URL receiving unit 151, a URL analyzing unit 152, and a URL storage unit 153. The URL receiving unit 151 receives the second URL information URL_inf2. The URL analyzing unit 152 may compare the second URL information URL_inf2 applied by the URL receiving unit 151 with the first URL information URL_inf1 applied by the URL storage unit 153 to analyze correlativity between the first URL information URL_inf1 and the second URL information URL_inf2.

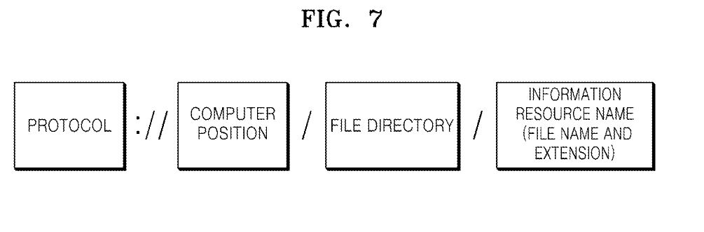

For example, the URL analyzing unit 152 determines whether the first URL information URL_inf1 and the second URL information URL_inf2 are the URL information items URL_inf on the continuous first and second web pages WPG1 and WPG2. For example, the URL analyzing unit 152 determines whether characters before information resource names included in the first URL information URL_inf1 and the second URL information URL_inf2 are the same. Each of the first URL information URL_inf1 and the second URL information URL_inf2 may consist of a protocol, a position of a computer having information resource, a file directory, and an information resource name as illustrated in FIG. 7. Data may be transmitted and received between different apparatuses by a protocol such as http. A colon and two slashes “://” are added after the protocol. The position of the computer having the information resource, the file directory, and the information resource name may be distinguished from each other by slashes “/”.

The position of the computer having the information resource represents a domain name of a site such as “naver.com”. That is, the position of the computer having the information resource represents that the information resource is positioned in a server computer of naver. At this time, the information resource as information provided by a computer network may be in the form of a file. The file directory as a file path on which the information resource is positioned in the corresponding computer may have a hierarchical structure. When the file directory includes lower directories, the directories are distinguished from each other by slashes “/”. The information resource name consists of a file name and an extension. The file name and the extension are distinguished from each other by a dot “.”.

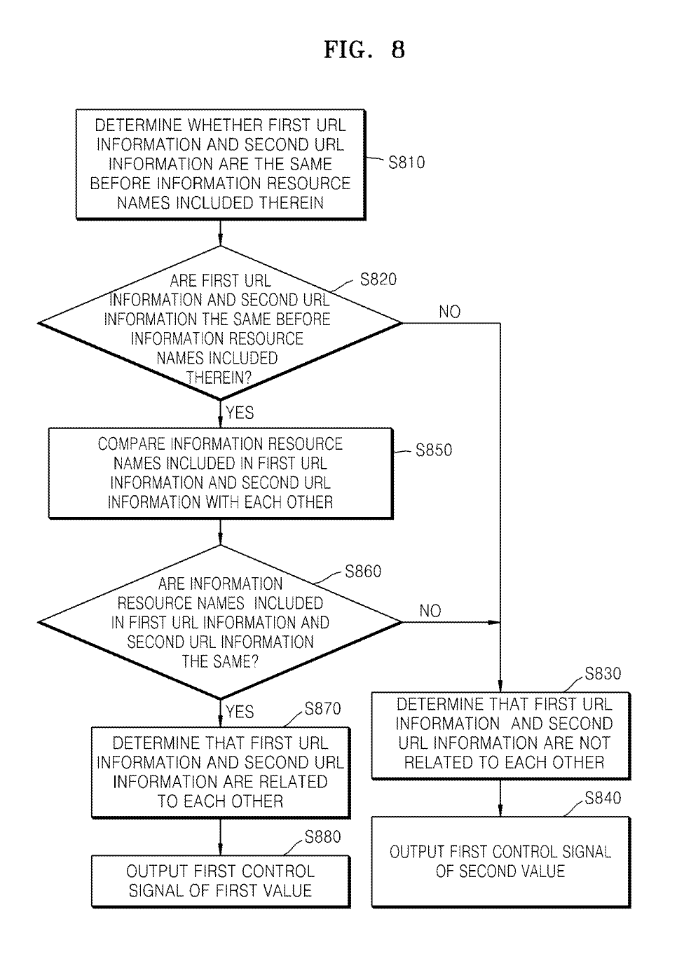

Hereinafter, an operation of the determining unit 150 of FIG. 6 will be described with reference to a flowchart of FIG. 8. Referring to FIGS. 6 and 8, as described above, the URL analyzing unit 152 may determine whether the first URL information URL_inf1 and the second URL information URL_inf2 are the same excluding the information resource names included therein (S810). For example, the URL analyzing unit 152 may compare characters before the last slash “/” included in the first URL information URL_inf1 and the second URL information URL_inf2. When it is determined that all the characters before the information resource names included in the first URL information URL_inf1 and the second URL information URL_inf2 are not the same (NO of S820), the URL analyzing unit 152 may determine that the first URL information URL_inf1 and the second URL information URL_inf2 are not related to each other (S830). In this case, the URL analyzing unit 152 may determine that the first web page WPG1 and the second web page WPG2 are not continuous to output the first control signal XCON1 of a second value (S840).

On the other hand, when it is determined that all the characters before the information resource names included in the first URL information URL_inf1 and the second URL information URL_inf2 are the same (YES of S820), the URL analyzing unit 152 compares the information resource names, that is, file names included in the first URL information URL_inf1 and the second URL information URL_inf2 (S850). For example, the URL analyzing unit 152 may compare the file names between the last slashes “/” and the dots “.” included in the first URL information URL_inf1 and the second URL information URL_inf2. At this time, when it is determined that the file names included in the first URL information URL_inf1 and the second URL information URL_inf2 are the same (YES of S860), it may be determined that the first URL information URL_inf1 and the second URL information URL_inf2 are related to each other (S870). When it is determined that the file names included in the first URL information URL_inf1 and the second URL information URL_inf2 are completely or partially the same, it may be determined that the file names included in the first URL information URL_inf1 and the second URL information URL_inf2 are the same.

In this case, the URL analyzing unit 152 may determine that the first web page WPG1 and the second web page WPG2 are continuous to output the first control signal XCON1 of the first value (S880). On the other hand, when it is determined that the file names included in the first URL information URL_inf1 and the second URL information URL_inf2 are not the same (NO of S860), the URL analyzing unit 152 may determine that the first URL information URL_inf1 and the second URL information URL_inf2 are not related to each other (S830), that is, the first web page WPG1 and the second web page WPG2 are not continuous to output the first control signal XCON1 of the second value (S840).

In the above, the determining unit 150 of FIG. 6 determines correlativity between the continuously received first URL information URL_inf1 and second URL information URL_inf2 to determine whether the first web page WPG1 and the second web page WPG2 are continuous web pages. The mobile device 100 may automatically apply the scale of the first web page WPG1 to the second web page WPG2 in accordance with the determination result of the determining unit 150 (the first control signal XCON1) to accommodate a user.

As described above, the second URL information URL_inf2 may be input to the interface unit 110 after the first URL information URL_inf1 is input and then, at least one URL information item is further input. That is, the first URL information URL_inf1 and the second URL information URL_inf2 may not be continuously received. In this case, the URL storage unit 153 may store an arbitrary number of URL information items from the first URL information URL_inf1 to URL information received before the second URL information URL_inf2. Then, comparing the first URL information URL_inf1 with the second URL information URL_inf2 of FIG. 8 may be performed on the second URL information URL_inf2 and the arbitrary number of URL information items stored in the URL storage unit 153. Therefore, when the same first URL information URL_inf1 as the second URL information URL_inf2 exists in the URL storage unit 153, the URL analyzing unit 152 may determine that the first web page WPG1 and the second web page WPG2 are continuous to output the first control signal XCON1 of the first value (S880). At this time, the scale control unit 140 may include scale information SCL_inf on the URL information items from the first URL information URL_inf1 to the URL information received before the second URL information URL_inf2, which are stored in the URL storage unit 153.

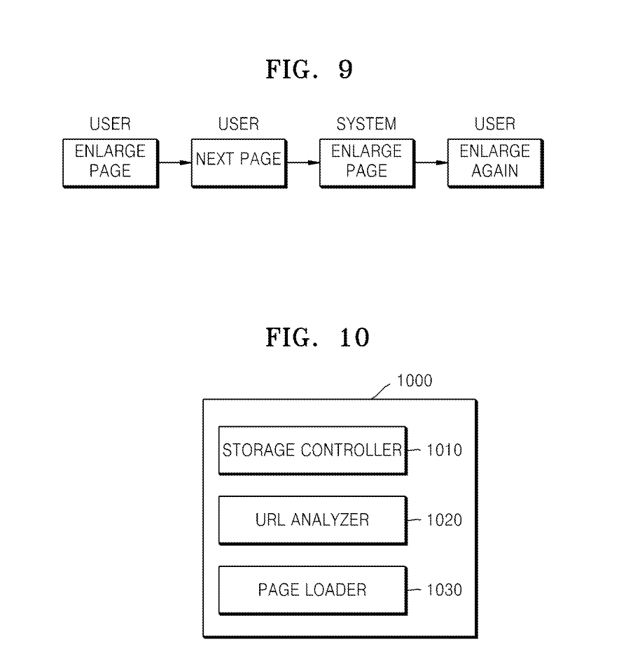

FIG. 9 is a view illustrating an example embodiment of an operation in contrast with an operation of a mobile device 100 according to some example embodiments of the inventive concepts. Referring to FIG. 9, when web page browsing is performed by a mobile terminal, a user increases a scale of a web page and clicks a next page after a current page is finished. Then, a system loads a new web page in accordance with a default page display scale. Then, the user increases the scale of the web page again in order to watch the continuous web pages. When a user watches continuous pages, in particular, when the user watches a web page divided into a plurality of pages, the user must control the respective web pages to have an appropriate font for reading the web pages before watching the web pages.

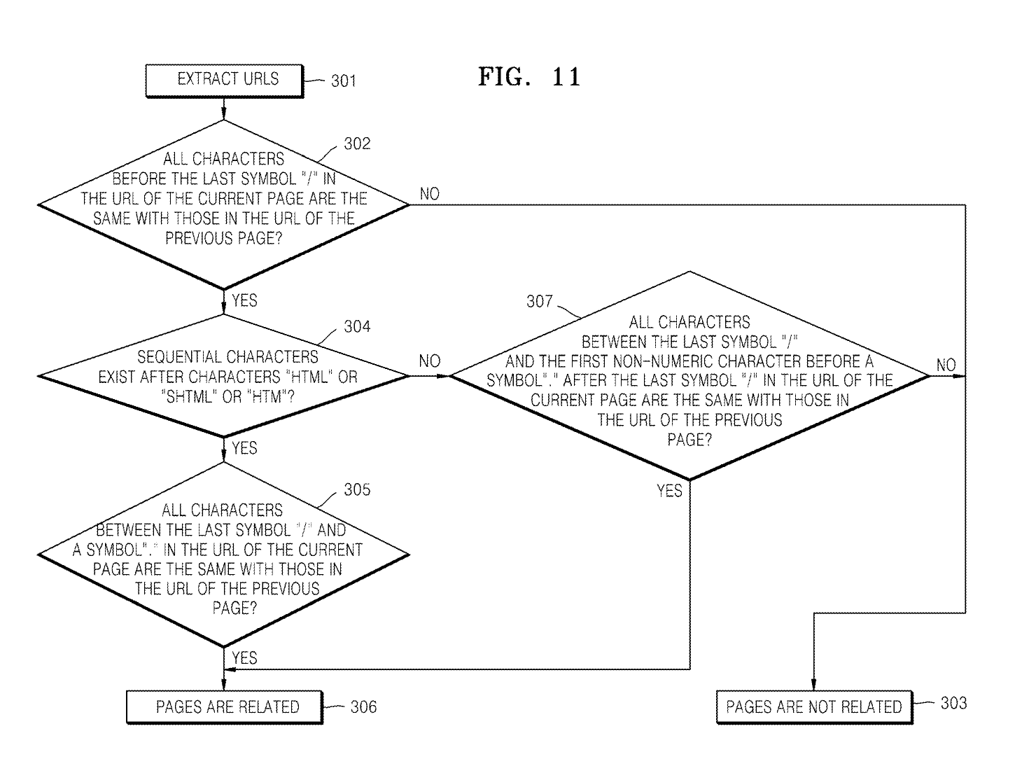

FIG. 10 is a view more conceptually illustrating the mobile device of FIG. 1. Referring to FIG. 10, a mobile device 1000 includes a storage controller 1010 for efficiently displaying continuous web pages, a URL analyzer 1020, and a page loader 1030. When a user watches a web page and controls a page display scale of the web page, the storage controller 1010 controls storage of page display scale control data of the shown web page input by the user in a storage unit. The storage controller 1010 may correspond to the scale control unit 140 of FIG. 1. The scale control data may correspond to the scale information SCL_inf or the scale control signal SCL_con of FIG. 1.

When a page turning command input by the user is received, the URL analyzer 1020 analyzes a relationship between a current page and a previous page. As described above, the page turning command is not an additional command and may be automatically generated by a touch of the user.

The URL analyzer 1020 may correspond to the determining unit 150 of FIG. 1. The page loader 1030 loads a web page in accordance with the analysis result of the URL analyzer 1020. The page loader 1030 may correspond to the web data loading unit 120 of FIG. 1. For example, when the page turning command is input by the user, the URL analyzer 1020 compares a URL of the current page with a URL of the previous page to analyze the relationship between the current page and the previous page. The URL may correspond to the URL information URL_inf of FIG. 1. For example, the URL analyzer 1020 compares characters of a desired part (that may or may not be predetermined) of the URL of the current page with those of a desired part (that may or may not be predetermined) of the URL of the previous page to analyze the relationship between the current web page and the previous web page.

When the URL analyzer 1020 determines that the current page (for example, a newly loaded page) is not related to the previous page, the URL analyzer 1020 removes the page display scale control data stored in the storage unit and the page loader 1030 loads a new page in accordance with a default page display scale. When the URL analyzer 1020 determines that the current page (for example, the newly loaded page) is related to the previous page, the URL analyzer 1020 extracts page display scale control data of the previous page from the storage unit and loads a new page by using the page display scale control data. Since the newly loaded page is immediately displayed in accordance with the page display scale control data, the user may watch continuous web pages without repeatedly controlling all the web pages.

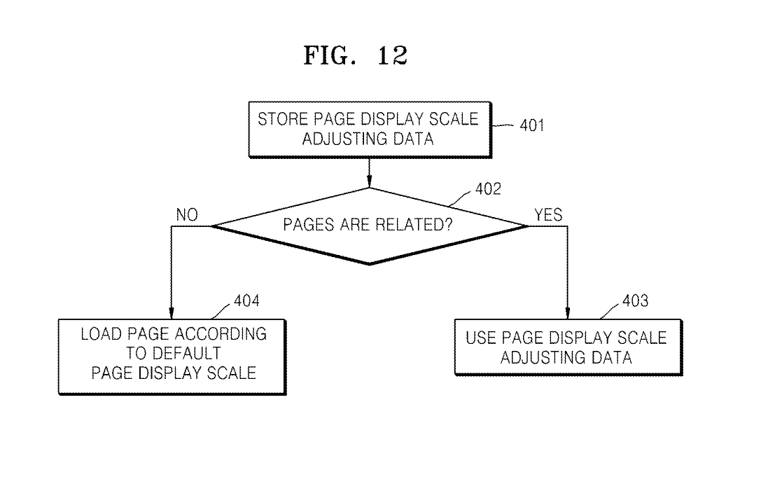

FIG. 11 is a flowchart illustrating an example embodiment of an operation of the URL analyzer of FIG. 10. Referring to FIG. 11, in operation 301, URLs of a previous page and a current page are extracted. In operation 302, all the characters before the last symbol “/” of the URL of the current page are compared with those of the URL of the previous page. The file directory and the information resource name may be distinguished from each other by the last symbol “/” as illustrated in FIG. 7. For example, when the URL of the current page is “http://china.nikkeibp.com.cn/news/tren/62510-20120829.html?start=1” and the URL of the previous page is “http://china.nikkeibp.com.cn/news/tren/62510-20120829.html”, the characters “http://china.nikkeibp.com.cn/news/tren” of the URL of the current page are compared with the characters “http://china.nikkeibp.com.cn/news/tren” of the URL of the previous page. When it is determined that all the characters are the same, a process proceeds to operation 304. When it is determined that all the characters are not the same, a process proceeds to operation 303.

In the operation 303, it is determined that the current page is not related to the previous page. For example, it is determined that the current page and the previous page are not continuous pages. In the operation 304, it is determined whether continuous characters follow the character “html”, “shtml”, or “htm” in at least one of the URLs of the current page and the previous page. When it is determined that continuous characters follow the character “html”, “shtml”, or “htm” in at least one of the URLs of the current page and the previous page, a process proceeds to operation 305. When it is determined that no continuous characters follow the character “html”, “shtml”, or “htm” in at least one of the URLs of the current page and the previous page, a process proceeds to operation 307. “html”, “shtml”, or “htm” is the extension illustrated in FIG. 7.

In the operation 305, all the characters between the last symbol “/” and a symbol “.” after the last symbol “/” of the URL of the current page are compared with those of the URL of the previous page. For example, when the URL of the current page is “http://china.nikkeibp.com.cn/news/tren/62510-20120829.html?start=1” and the URL of the previous page is “http://china.nikkeibp.com.cn/news/tren/62510-20120829.html”, the characters “62510-20120829” of the URL of the current page are compared with the characters “62510-20120829” of the URL of the previous page. When it is determined that all the characters are the same, in operation 306, it is determined that the current page is related to the previous page. For example, it is determined that the current page and the previous page are continuous pages. When it is determined that all the characters are not the same, in the operation 303, it is determined that the current page is not related to the previous page.

In the operation 307, all the characters between the last symbol “/” and a first character that is not a number before a symbol “.” after the last symbol “/” of the URL of the current page are compared with those of the URL of the previous page. For example, when the URL of the current page is “http://news.sina.com.cn/c/sd/2012-09-14/100125173047_{—}2.shtml” and the URL of the previous page is “http://news.sina.com.cn/c/sd/2012-09-14/100125173047.shtml”, the characters “100125173047” of the URL of the current page are compared with the characters “100125173047” of the URL of the previous page. When it is determined that all the characters are the same, in the operation 306, it is determined that the current page is related to the previous page. For example, it is determined that the current page and the previous page are continuous pages. When it is determined that all the characters are not the same, in the operation 303, it is determined that the current page is not related to the previous page.

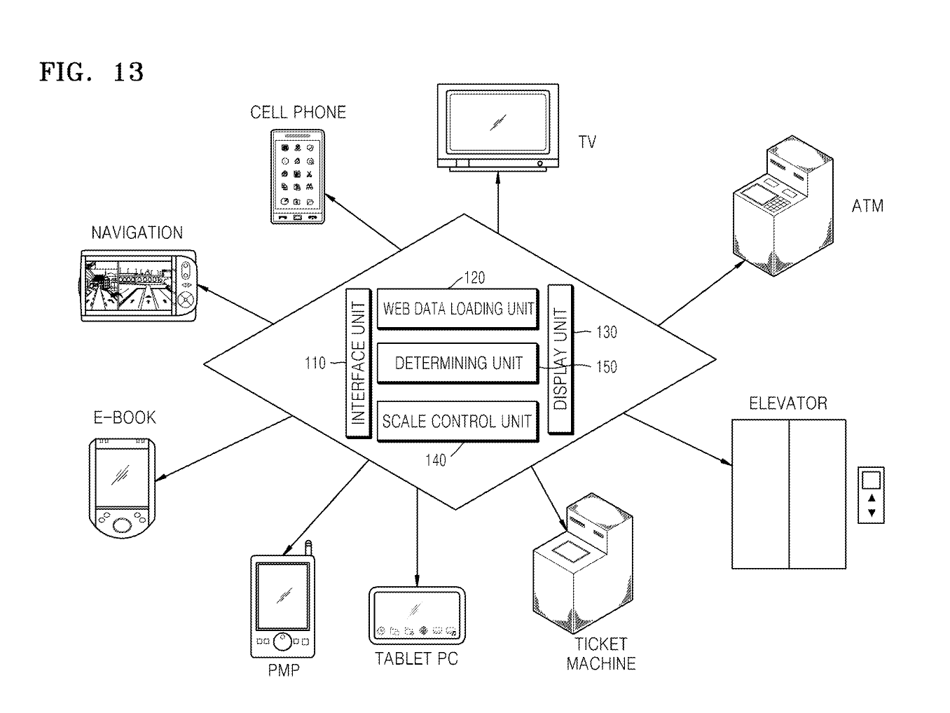

FIG. 12 is a flowchart illustrating a method of watching continuous web pages in a mobile device according to some example embodiments of the inventive concepts. Referring to FIG. 12, in operation 401, page display scale control data input by a user is stored. In operation 402, when a page turning command is received, a relationship between a current page and a previous page is analyzed by comparing a URL of the current page with that of the previous page. In particular, the URL analyzer 1020 compares characters of a desired part (that may or may not be predetermined) of the URL of the current page with those of a desired part (that may or may not be predetermined) of the URL of the previous page to analyze the relationship between the current page and the previous page. When the current page is related to the previous page, for example, when it is determined that the current page and the previous page are continuous pages, a process proceeds to operation 403. When the current page is not related to the previous page, a process proceeds to operation 404.

In the operation 403, the current page is loaded by using stored page display scale control data. In the operation 404, the current page is loaded in accordance with a default page display scale. According to the inventive concepts, while watching the continuous pages, a new page is loaded by using page display scale control data of the previous page and is activated to be suitable for the user reading the page. Since the user does not have to control all the continuous pages, a user experience is improved.

FIG. 13 is a view illustrating an example of an electronic device according to some example embodiments of the inventive concepts. Referring to FIG. 13, the interface unit 110, the web data loading unit 120, the display unit 130, the scale control unit 140, and the determining unit 150 provided in the mobile device 100 of FIG. 1 to maintain a scale of a related web page may be applied to various electronic devices such as a mobile phone, a television (TV), an automatic teller machine (ATM) of a bank, an elevator, a ticket machine used in a subway, a project management professional (PMP), an e-book, a navigator, and a tablet personal computer (PC). Therefore, the electronic device according to some example embodiments of the inventive concepts may efficiently provide a web page to a user.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A mobile device, comprising:
an interface unit configured to receive first uniform resource locator (URL) information from a user, and configured to receive second URL information;
a web data loading unit configured to load a first web page corresponding to the first URL information from a web server that the first URL information represents, and configured to load a second web page corresponding to the second URL information from a web server that the second URL information represents;
a determining unit configured to compare the first URL information with the second URL information to determine whether the first web page is related to the second web page and to generate a first control signal;
a scale control unit configured to generate a scale control signal corresponding to scale information of the first web page in response to the first control signal; and
a display unit configured to receive the scale control signal to display the second web page in a scale corresponding to the scale information of the first web page.

2. The mobile device of claim 1, wherein the determining unit comprises a URL analyzer for comparing the first URL information and the second URL information continuously input to the interface unit with each other to determine whether the second web page is continuous to the first web page and to generate the first control signal.

3. The mobile device of claim 1, wherein the determining unit comprises a URL analyzer for comparing the second URL information to the first URL information to determine whether the second web page is the same as or continuous to the first web page and to generate the first control signal, and
wherein the second URL information is input to the interface unit after the first URL information is received and then at least one other URL information is received.

4. The mobile device of claim 1, wherein the determining unit comprises a URL analyzer configured to determine whether the first URL information and the second URL information are the same, excluding information resource names included therein, and when it is determined that the first URL information and the second URL information are the same, excluding the information resource names included therein, configured to compare the information resource names of the first URL information and the second URL information with each other to generate the first control signal.

5. The mobile device of claim 1, wherein the scale control unit is configured to generate the scale control signal corresponding to a default value in the display unit displaying a web page when the first control signal represents that the first web page and the second web page are not related to each other, and is configured to generate the scale control signal corresponding to scale information of the second web page when scale information of the second web page is input to the interface unit, and
wherein the display unit is configured to display the second web page in a scale in accordance with the scale control signal.

6. A method of watching continuous web pages in a mobile device, the method comprising:
controlling storage in order to store page display scale control data input by a user;
comparing a uniform resource locator (URL) of a current page with that of a previous page to analyze a relationship between the current page and the previous page when a page turning command input by the user is received; and
loading a page in accordance with the analysis result.

7. The method of claim 6, wherein the loading of the page in accordance with the analysis result comprises:
loading the current page by using the stored page display scale control data when it is determined that the current page is related to the previous page; and
loading the current page by using default display scale control data when it is determined that the current page is not related to the previous page.

8. The method of claim 6, wherein the analyzing of the relationship between the current page and the previous page comprises:
comparing characters of a part of the URL of the current page with those of a part of the URL of the previous page to determine that the current page is related to the previous page when all the characters of the part of the URL of the current page are the same as those of the part of the URL of the previous page.

9. The method of claim 8, wherein the characters of the part comprise all the characters before a last symbol “I” of the URL.

10. The method of claim 9, wherein when continuous characters follow a character “html”, “shtml”, or “htm” in at least one of the URLs of the current page and the previous page, the characters of the part further comprise all the characters between the last symbol “/” and a symbol “.” after the last symbol “/”.

11. The method of claim 9, wherein when no continuous characters follow a character “html”, “shtml”, or “htm” in at least one of the URLs of the current page and the previous page, the characters of the part further comprise all the characters between the last symbol “/” and a first character that is not a number before a symbol “.” after the last symbol “/”.

12. A mobile device, comprising:
a storage controller configured to control storage in order to store page display scale control data input by a user;
a uniform resource locator (URL) analyzer configured to compare a URL of a current page with that of a previous page to analyze a relationship between the current page and the previous page when a page turning command input by a user is received; and
a page loader configured to load the current page in accordance with the analysis result.

13. The mobile device of claim 12, wherein the page loader is configured to load the current page by using the stored page display scale control data when it is determined by the URL analyzer that the current page is related to the previous page, and
wherein the page loader is configured to load the current page by using default display scale control data when it is determined by the URL analyzer that the current page is not related to the previous page.

14. The mobile device of claim 12, wherein the URL analyzer is configured to compare characters of a part of the URL of the current page with those of a part of the URL of the previous page to determine that the current page is related to the previous page when it is determined that all characters of the part of the URL of the current page are the same as those of the part of the URL of the previous page.

15. The mobile device of claim 12, wherein characters of the part comprise all the characters before a last symbol “/”,
wherein when continuous characters follow a character “html”, “shtml”, or “htm” in at least one of the URLs of the current page and the previous page, the characters of the part further comprise all the characters between the last symbol “/” and a symbol “.” after the last symbol “/”, and
wherein when no continuous characters follow the character “html”, “shtml”, or “htm” in at least one of the URLs of the current page and the previous page, the characters of the part further comprise all the characters between the last symbol “/” and the first character that is not a number before the symbol “.” after the last symbol “/”.

16. A mobile device, comprising:
a touch panel configured to receive first uniform resource locator (URL) information from a user, and configured to receive second URL information;
a web data loading unit configured to load a first web page corresponding to the first URL information from a web server that the first URL information represents, and configured to load a second web page corresponding to the second URL information from a web server that the second URL information represents;
a determining unit configured to compare the first URL information with the second URL information to determine whether the first web page is related to the second web page and to generate a first control signal; and
a scale control unit configured to generate a scale control signal corresponding to scale information of the first web page in response to the first control signal, and configured to provide the scale control signal to the touch panel.

17. The mobile device of claim 16, further comprising:
a display unit configured to display the second web page in a scale corresponding to the scale information of the first web page.

18. The mobile device of claim 16, wherein the touch panel further comprises:
a display unit configured to display the second web page in a scale corresponding to the scale information of the first web page.

19. The mobile device of claim 16, further comprising:
a display unit configured to receive the scale control signal to display the second web page in a scale corresponding to the scale information of the first web page.

20. The mobile device of claim 16, wherein the touch panel further comprises:
a display unit configured to receive the scale control signal to display the second web page in a scale corresponding to the scale information of the first web page.
